(19) United States
(12) Patent Application Publication
(10) Pub. No.: US 2015/0371328 A1
(43) Pub. Date: Dec. 24, 2015

(54) DEMAND BIDDING OPERATION AND BID GENERATION

(71) Applicant: Honeywell Internatioanl Inc., Morristown, NJ (US)

(72) Inventors: Steve Gabel, Golden Valley, MN (US); George Bell, Corona, CA (US); Jack Rosenthal, Los Alamitos, CA (US); John Hurd, Houston, TX (US)

(21) Appl. No.: 14/719,632

(22) Filed: May 22, 2015

Related U.S. Application Data
(60) Provisional application No. 62/015,160, filed on Jun. 20, 2014.

(51) Int. Cl. G06Q 40/04; G06Q 50/06

(52) U.S. Cl. CPC G06Q 40/04; G06Q 50/06

(57) ABSTRACT

Methods and devices for demand bidding operation are described herein. One method of demand bidding operation includes determining a potential electric demand reduction for a particular facility, determining a bid for demand reduction based upon the determined potential electric demand reduction, submitting, via a computing device, the bid for demand reduction to a computing device of an electrical demand coordinating entity, receiving, via a computing device, notification of a triggering event that will trigger the demand reduction based upon the bid, and adjusting, via a computing device, demand at the particular facility based upon the demand reduction of the bid.

### GOVERNMENT RIGHTS

This invention was made with Government support under Contract Number: W912HQ-12-C-0030.

### TECHNICAL FIELD

The present disclosure relates to methods, devices, system, and computer-readable media for customer participation in utility demand bidding programs.

### BACKGROUND

Electricity is provided to users through a power grid that is comprised of power plants owed by many power entities. These entities typically run at near capacity, but not at capacity all of the time. However, due to concerns about energy efficiency and grid reliability, there has been interest in occasionally reducing the amount of power demand from utility customers.

### BRIEF DESCRIPTION OF THE DRAWINGS

FIG. 1 is a system overview illustrating how the customer interacts with the utility in a Demand Bidding Program (DBP) in one or more embodiments of the present disclosure. The method and system can reside in the building energy management system (BEMS) at the customer site.

FIG. 2 illustrates a user interface which includes interfacing with the DBP Control Table according to one or more embodiments of the present disclosure.

FIG. 3 is a state diagram illustrating the operation of the DBP Control Table according to one or more embodiments of the present disclosure.

FIG. 4 shows the DBP bid data that is exported from the system according to one or more embodiments of the present disclosure.

FIG. 5 illustrates a computing device that can be utilized according to one or more embodiments of the present disclosure.

### DETAILED DESCRIPTION

The embodiments of the present disclosure facilitate an electric customer's participation in a utility Demand Bidding Program (DBP) by providing a number of functions, for example; 1) monitoring the status and energy usage of a set of controllable electric loads, 2) enabling the preparation of demand reduction bids to be submitted to the utility, 3) receiving electronically-delivered commands from the utility during DBP events, and 4) automatically implementing pre-programmed demand reduction control strategies.

For each controllable load, a mathematical model of the time profile of electric demand can be calculated from a specified period of past history. Demand reduction values for each load are calculated from the values of the respective control setting, the model demand, and the full load rating. A total estimated electric demand reduction for the combined set of electric loads can be used by the customer in preparing a bid to the utility DBP coordinator. To better understand how the embodiments of the present disclosure work, some information about the demand process is provided below.

### Demand Response

Demand response (DR) can be defined as a tariff or program established to motivate changes in electric use by end-use customers in response to changes in the price of electricity over time, or to give incentive payments designed to induce lower electricity use at times of high market prices or when grid reliability is jeopardized.

### Demand Response Event

A demand response event can be defined as a period of time identified by the demand-response program sponsor when it is seeking reduced energy consumption and/or load from customers participating in the program. Depending on the type of program and event (economic or emergency), customers are expected to respond or decide whether to respond to the call for reduced load and energy usage.

The program sponsor generally will notify the customer of the demand-response event before the event begins, and when the event ends. Generally, each event is a certain number of hours, and the program sponsors are limited to a maximum number of events per year.

### Utility-Based Demand Response Programs

Most demand response programs are utility based and are focused on peak shaving and emergency applications. As new paradigms for electric customer DR participation develop, embodiments of the present disclosure may have opportunities for application to wholesale electricity market-based DR programs as well.

### Market-Based Demand Response Programs

In general, the goal of such programs is to provide demand response and energy efficiency that are integral, dependable, and predictable resources that support a reliable, environmentally sustainable electric power system.

In some states in the United States, rules have been put in place that enable direct participation by DR resources in the Independent System Operator (ISO) wholesale market. Some of these rules include creating retail tariff options that align with grid conditions, developing the means to reflect grid conditions to consumers (e.g., via utility tariffs), and conducting pilot programs.

### Incentive Based Demand Response

Generally, demand response programs can be categorized into two groups: incentive-based demand response and time-based rates. Incentive-based demand response programs can be defined to include, for example: direct load control, interruptible/curtailable rates, demand bidding/buyback programs, emergency demand response programs, capacity market programs, and ancillary services market programs.

Incentive-based programs offer end-use customers economic payments to reduce their demand at times when the supply/demand balance in the system is tight. These programs seek to make the economic incentives reflect the time-varying wholesale cost of electricity.

### Demand Bidding Programs

Demand bidding programs (DBP) can be defined as: programs that (1) encourage large customers to bid into a wholesale electricity market and offer to provide load reductions at a price at which they are willing to be curtailed, or (2) encourage customers to identify how much load they would be willing to curtail at a utility-posted price.

These load reductions are typically scheduled day-ahead, and incentive payments are valued and coordinated with day-ahead energy markets. DBP events can have any duration, but a typical event may have a duration, for example, lasting from noon to 8 pm.

### Utility Demand Bidding Programs

A Demand Bidding Program (DBP) can, for example, be a year round bidding program that offers day-ahead price incentives to customers for reducing energy consumption during a DBP event. A DBP event, may be called at a program sponsor's discretion, when it is needed based, for example, on ISO emergencies, day-ahead load and/or price forecasts, extreme or unusual temperature conditions impacting system demand, and/or the program sponsor's procurement needs.

Customers enrolling in a DBP program can receive a flat rate credit equal to an amount (e.g., 50 cents) per kWh of load reduction for participation in a DBP event. A DBP billing credit will apply to any amount of actual load reduction that is over a threshold amount (e.g., 50 percent or greater and less than or equal to 200 percent of the customer's DBP bid).

Once triggered, a DBP event may be in effect for a defined period, for example, between 12 noon and 8:00 p.m. Monday through Friday, excluding holidays. In some implementations, the program sponsor will begin to notify a customer at, or about 12 noon, the day before an event. Notification of DBP events can be provided by telephone, electronic mail, pager, fax, an application programming interface (API), SMS text, or any other suitable communication methods.

For an event occurring on Monday or the day after a holiday, notifications may be given, for example, on the previous business day. The customer's DBP bid is the amount of kW per hour (kWh usage) that a customer commits to reduce during a DBP event.

The program sponsor can set the time period for when bids can be submitted. For example, in some implementations, the program sponsor can set a time period wherein customers may submit DBP bids no later than 4:00 p.m. on the business day preceding the day-ahead event. In some embodiments, customers may submit standing DBP bids, which remain in effect until the customer withdraws or modifies the standing bid. In various embodiments, bids can be submitted via a utility website.

Credits to customer's utility bills are based on the recorded reduced energy (RRE). The RRE equals the difference between the customer's energy baseline and the recorded kWh for each hour during a DBP event.

The customer's energy baseline can take the form of a “10-Day Average Baseline” which can, for example, be computed using a 10-day rolling average energy usage profile of the immediate past 10 similar days prior to the DBP event. This baseline can, for instance, be calculated on an hourly basis from 12 noon to 8:00 p.m. using the average of the same hour for the past 10 similar weekdays, excluding holidays. The past 10 similar days can also exclude other special days, as specified by the utility DBP program sponsor.

Although the present disclosure describes the operation of the embodiments in a utility DBP application, operation in a wholesale electricity market DBP program will be similar and, therefore, the scope of the embodiments includes wholesale electricity market DBP.

### Demand Response Applications

The power system is comprised of end-use devices and increasingly distributed resources that are inherently flexible. This flexibility can allow energy consumption or production to be shifted to another time without impacting customers' operations.

One approach is to consider the degree of flexibility specified for a resource (consuming or producing) as the quality of its service. Many temperature-sensitive loads exhibit flexibility in power demand, as their temperatures are not restricted to a single value, but rather are allowed to float within a specified band of temperatures. Such flexibility in demand amounts to a continuum of potential response to satisfy grid operations and customer need.

Further, HVAC systems can be an excellent resource for DR shed savings for several reasons. First, HVAC systems create a substantial electric demand in commercial buildings, often more than one third of the total demand.

Second, the thermal flywheel effect of indoor environments allows HVAC systems to be temporarily unloaded without immediate impact to the building occupants. Third, it is common for HVAC systems to be at least partially automated with a building energy management system (BEMS).

The present disclosure describes the operation of embodiments in building heating ventilating and air conditioning (HVAC) applications. Operation in non-HVAC applications (i.e., manufacturing, municipal water systems, etc.) will be similar and therefore the scope of the embodiments includes non-HVAC applications.

### Automated Demand Response

Automated demand response (Auto-DR) can be defined as fully automated signaling from a utility, Independent System Operator (ISO), Regional Transmission Operator (RTO) or other appropriate entity to provide automated connectivity to customer end-use control systems, devices, and strategies. Auto-DR can be beneficial, for example, by helping system operators reduce the operating costs of DR programs while increasing demand resource reliability. For customers, Auto-DR can reduce the resources and/or effort required to achieve successful results from these DR programs.

As discussed above, embodiments of the present disclosure facilitate an electric customer's participation in a utility DBP by providing a number of functions; 1) monitoring the status and energy usage of a set of controllable electric loads, 2) enabling the preparation of demand reduction bids to be submitted to the utility, 3) receiving electronically-delivered commands from the utility during DBP events, and 4) automatically implementing pre-programmed demand reduction control strategies in the customer's building energy management system. Appropriate user interfaces in the BEMS enable customer oversight and operation of each of these high level functions.

An electrical load can be an electrical device or any electrically driven equipment. A customer's participation in a DBP program can include quantifying an electric demand for a number of electrical loads, determining an electric demand reduction capability of the number of electrical loads over a specified period of time, preparing a bid based on the electric demand reduction capability of the number of electrical loads, and responding to instructions from the utility provider to reduce electric load when required.

The electric demand can be the rate at which electric power is consumed when operating an electrical load. For example, a heating and air conditioning unit can operate utilizing a particular amount of kilowatts (kW).

The particular amount of kilowatts can vary based on an operation level (e.g., on, off, high, medium, low, a percentage level, etc.). For example, a heating, ventilation, and air conditioning (HVAC) system can require a greater amount of power or electric demand when operating at a high level compared to operating at a lower level.

The electric demand reduction capability can be a quantity of power (i.e., kilowatts) that can be reduced by lowering the operation level of a number of electrical loads. For example, lowering the operation level of a lighting system can reduce its electric demand.

In this example, the amount of kilowatts not used by the lighting system after lowering the operation level can be a quantity of electric demand reduction that can be offered in a bid to a demand bidding program coordinator at an electric utility. Similar demand reduction abilities for HVAC equipment and other common building electric loads are also possible.

The demand reduction bid (DBP bid) by the customer can be prepared and submitted to provide information to a DBP coordinator in an electric utility. The information can include a number of time periods with an electric demand reduction that can be provided by the customer upon a request or command from the utility DBP coordinator. Having an electric customer submit bids to demand bidding programs can increase predictability of demand side resources by quantifying the electric demand reduction capabilities for a particular electric customer.

DBP events (periods when the utility requests a demand reduction by the customer) can be initiated by the utility DBP coordinator. The customer's DBP bids (together with actual demand reductions measured during DBP events and other information) can be the basis for utility bill credits paid by the utility to the customer for participation in a demand bidding program.

In the following detailed description, reference is made to the accompanying figures, which show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of this disclosure.

Elements shown in the various embodiments herein can be added, exchanged, combined, and/or eliminated so as to provide a number of additional embodiments of this disclosure. The proportion and the relative scale of the elements provided in the figures are intended to illustrate the embodiments of this disclosure, and should not be taken in a limiting sense.

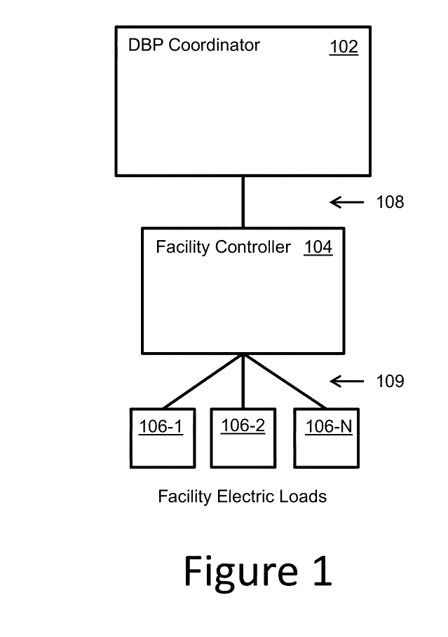

FIG. 1 illustrates an example of a demand bidding framework in accordance with one or more embodiments of this disclosure. This framework can include a DBP coordinator 102 (e.g., a computing device in an electric utility), and a facility controller 104 (e.g., a computing device at an electric customer) with a number of controllable electric loads 106-1, 106-2, 106-N (where “N” can be any number to represent that any number of loads can be supported by embodiments of the present disclosure).

The controlled electric loads (e.g., 106-1, 106-2, 106-N) can have the ability to send information about their operational status, electric demand, and electric consumption to the customer's building energy management system (e.g., on the computing device acting as the facility controller or a computing device in communication with the facility controller). This information can be used by the customer (e.g., user of the computing device above) to prepare bids of available demand reduction capability that can be sent to the utility DBP coordinator.

The customer may have a person (a computing device user) that acts as an energy manager who monitors the operation of the building, is responsible for analyzing the building's ability to reduce electric demand, and/or who is able to prepare and submit bids of available demand reduction capability to the utility DBP coordinator.

The DBP coordinator can have the ability to initiate a DBP event and command the customer to decrease the electric demand of the controllable loads (e.g., to respond to unusual conditions impacting the utility's distribution system or due to the utility's energy procurement needs).

For example, the DBP coordinator can send an electronic signal, via connection 108, to the electric customer indicating a need to reduce electric demand. The signal is received by the customer's building energy management system which can, for example, automatically alter the settings of the controllable loads to reduce electric demand.

The BEMS can be a computing device (e.g., facility controller 104) that is connected (e.g., via connections 109) to a number of electrical devices or loads within a building or campus (e.g., multiple buildings) to control and/or monitor the electrical loads. For example, the BEMS can be a computing device with computing device executable instructions that can be executed to monitor and/or control a building's ventilation system, lighting system, power system, fire system, security system, elevators, and/or heating and air conditioning system (e.g., HVAC system), among other systems.

Data can be collected from the number of electrical loads by a BEMS to determine a quantity of power consumed and/or electric demand for each of the number of electrical loads at various times or intervals (e.g., hourly) during a particular period (e.g., day, week, etc.) and can also include other relevant data (e.g., outdoor ambient temperature, etc.) at the various times during the particular period. For example, a HVAC system at an office building can have a greater electric demand during business hours compared to non-business hours and also have a greater demand on days with relatively high temperatures compared to days with lower temperatures.

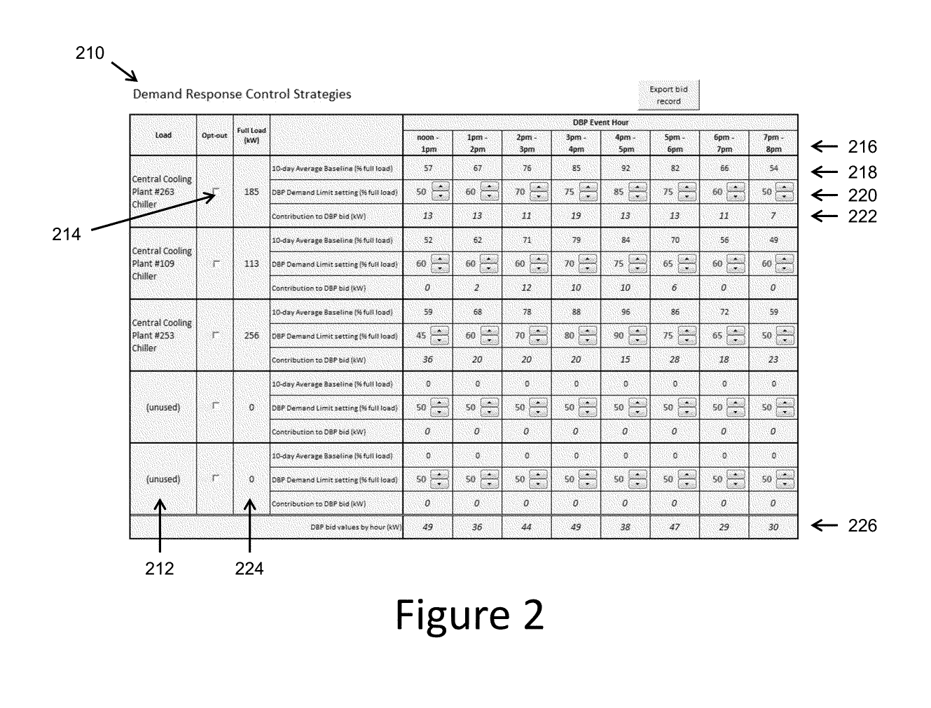

The data that is collected can be utilized in a control table (e.g., a DBP Control Table) stored in memory in a computing device (e.g., facility controller) or memory device, as shown in FIG. 2, in accordance with one or more embodiments of the present disclosure. This control table can contain a list of controllable electric loads 212 (e.g., by name or title), with the full load rating (maximum electric demand in kW) for each load.

The table or other method of presenting the data 210 can also include an opt-out control or setting 214, which allows the customer to enable or disable a particular load for participation in a utility DBP program (e.g., to respond or not respond to a DBP event). For example, the DBP Control Table can include a set of controllable electric loads pertaining to a HVAC system.

The table can include unused rows which can accommodate additional electric loads to be added in the future, if desired by the customer. For each controllable load, the DBP Control Table can contain energy (e.g., load, demand, etc.) information and control information that quantifies the available electric demand reduction capability. This energy and control data can be given for time intervals of a day (e.g., hourly from 12:00 pm to 8:00 pm, etc.). These time intervals can be aligned with the DBP event schedule defined by the utility.

For each controllable load, the DBP Control Table can contain a model (e.g., mathematical model, representation of equipment behavior, etc.) of the time profile of electric demand (as calculated from a specified period of past history during which no DBP events were present). The model can include individual numeric values, each corresponding to a specified time interval 216 (e.g., hour) as defined in the utility's DBP program.

The model 218 can include estimated values that are manually entered by the customer, or it can be a calculated model, for example, based on measured historical data (e.g., acquired from an electric sub-meter at the load). The calculated model can utilize an industry standard algorithm (e.g., to give credibility to the quality of the model), or a custom designed mathematical model.

The industry standard algorithm could, for example, be a 10-day average baseline algorithm as commonly used in the electric utility industry. The model values can be expressed as a percentage of the full load rating of the associated electric load (rather than in kW).

For each controllable load, the DBP Control Table can contain a time-based set of pre-programmed control commands (e.g., operating setpoints, etc.) to be sent to the controllable electric loads at the start of each hour during a DBP event. The pre-programmed control commands can include individual settings, each corresponding to a specified time interval (e.g., hour) as defined in the utility's DBP program.

The control settings can be expressed as a demand limit in percentage of full load rating of the controlled load 220. Other control settings are also possible (e.g., on/off, a percentage level, etc.).

By raising the control setting to the maximum level (i.e., 100%), the customer can effectively de-select a particular load from participating in DBP events for specified intervals of time. These individual control settings can be adjusted by the customer to manage the customer's objectives for energy use, cost savings, space comfort, and/or other criteria.

For each controllable load, the DBP Control Table can contain a time-based set of estimated electric demand reduction values (i.e., electric demand reduction which could be delivered during a DBP event). The set of estimated electric demand reduction values can include individual numeric values 222 (in kW), each corresponding to a specified time interval (e.g., hour) as defined in the utility's DBP program. For each controllable load, these hourly demand reduction values are calculated from the values of the respective control setting, the model demand, and the full load rating 224.

The DBP Control Table can contain a time-based set of total (e.g., summation of) estimated electric demand reduction for the combined set of controllable electric loads (i.e., the total electric demand reduction which could be delivered during a DBP event) 226. The set of total estimated electric demand reduction values can include individual numeric values (in kW), each corresponding to a specified time interval (e.g., hour) as defined in the utility's DBP program.

This time-based set of total estimated electric demand reduction for the combined set of controllable electric loads can be used by the customer in preparing the DBP bid to be submitted to the utility DBP coordinator. The DBP Control Table can include a button which causes this information to be exported in an electronic data file for use by the customer in preparing and submitting a DBP bid.

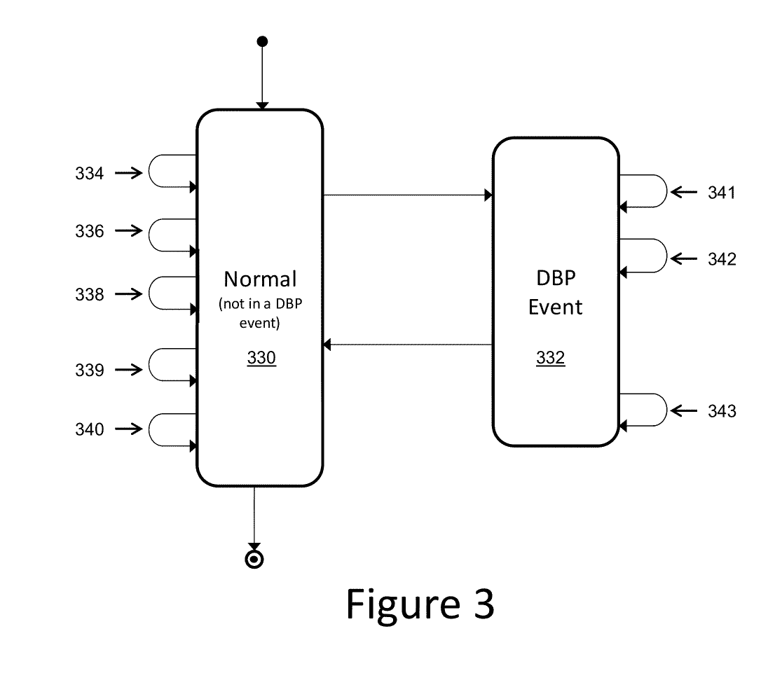

Embodiments of the present disclosure can have two operating states; a normal state 330 and a DBP event state 332 as shown in FIG. 3, in accordance with one or more embodiments. For instance, the normal state is entered upon the start of operation.

When the proper conditions are present, operation can transition to the DBP event state. From the DBP event state, when the proper conditions are present, operation can transition to the normal state.

When in the normal state, an embodiment can, for example:
automatically calculate a new or updated set of values for the model (e.g., a 10-day average baseline) for each controlled load (typically at the start of each day),
respond to inputs from the customer, to make changes to the settings in the DBP Control Table, (e.g., control settings, etc.). If an “opt-out” button is clicked, the control output or setting for that load is set to 100%, and the DBP bid values for that load are recalculated,
respond to inputs from the customer, to export DBP bid values to an electronic file for use by the customer,
respond to inputs from the customer, to make changes to the electric demand model in the DBP Control Table, (i.e., if there is no sub-meter available for a controlled load, the hourly model values can be set as constants that are adjustable by the customer),
transition to the DBP event state (e.g., at the beginning of a DBP event), as directed by a communication from the utility (if DBP control is not globally disabled).

When in the DBP event state, embodiments of the present disclosure can:
respond to inputs from the customer, to make changes to the settings in the DBP Control Table, (e.g., if an “opt-out” button is clicked, the control output or setting for that load is set to 100%, or if a control setting is modified, the new setting is sent to the controlled load and the DBP bid values are recalculated, etc.),
respond to inputs from the customer, to export DBP bid values to an electronic file for use by the customer,
transition to the normal state; when the DBP event ends as directed by a communication from the utility, or if DBP control is globally disabled by the customer. Upon this transition, the control outputs to all controlled loads are set to 100%.

In response to a command from the customer, embodiments of the present disclosure can produce a set of time-based data that estimates the total electric demand reduction for the combined set of controllable electric loads. This data can be exported in an electronic file to be used by the customer in preparing a DBP bid to be submitted to the utility DBP coordinator.

An example of a normal state process is provided below. For example, at the start of each day (or at another suitable time), a new set of values for the model can be calculated (e.g., a 10-day average baseline) for each controlled load, for example at 334. Inputs from the customer are responded to, to make changes to the settings in the DBP control table, for example, at 336. If an opt-out designation is selected, the control output for that load is set to 100% and the DBP hourly values are recalculated.

In response to a customer command, the DBP hourly bid values can be exported to an electronic file, for example at 338.

In some embodiments, the hourly values in the electric demand model can be set as constants that can be adjusted by a user, for example if there is no sub-meter available, for instance at 340.

A DBP event can be triggered, for example, by an electrical signal or other type of communication from the utility. The end of an event can also be communicated in a similar manner, in some embodiments. In some embodiments, the customer computing device can initiate and end an event based on information from the bid process regarding the start time and stop time of potential DBP events.

During a DBP event, at the start of each hour, or at another suitable time, control outputs to each controlled load are updated, for example at 341. Inputs from the customer can be responded to, to make changes to the settings in the DBP Control Table, for example at 342. If an opt-out designation is selected, the control load for that load is set at 100%. If a control setting is modified, the new setting is sent to the controlled load and the DBP hourly bid values are recalculated. In response to a customer command, the DBP hourly bid values can be exported to an electronic file, for example at 339 or 343.

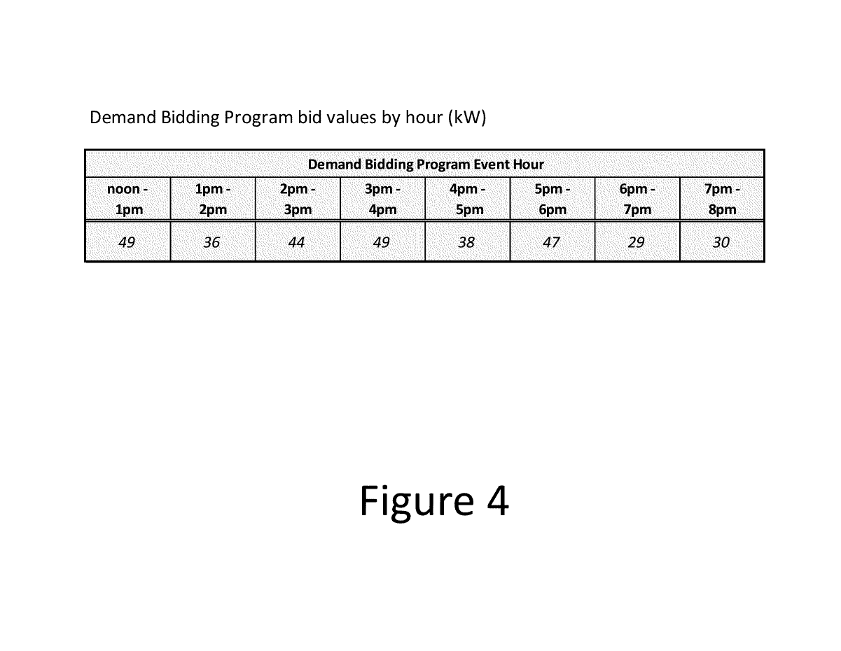

An example of the form of the exported data is as shown in FIG. 4, in accordance with one or more embodiments of the disclosure. The DBP bids (in kW) can be given for specified time intervals of a day (e.g., hourly from 12:00 pm to 8:00 pm, etc.). These time intervals can be aligned with the DBP event schedule defined by the utility.

Provided below are some examples of some embodiments and features of embodiments of the present disclosure. In an example method, a method for controlling a set of electric loads, can include:
quantifying the typical energy use information (e.g., demand, etc.) for each of the electric loads,
defining control commands or settings for modifying the loads operating condition (e.g., to reduce electric demand) to be sent to each of the electric loads during periods when a reduction in electric demand is required,
quantifying the electric demand reduction capability that is available for each of the electric loads during periods when a demand reduction is required, and
quantifying the total electric demand reduction capability that is available for (a summation of) the combined set of electric loads during periods when a demand reduction is required. In some such embodiments, the energy use information, control commands, and demand reductions are defined for specific time intervals (e.g., hours), and are associated with the occurrence of a pre-defined event whose purpose is to reduce electric demand. The control commands can be adjusted by the electric customer to manage the customer's objectives for energy use, cost savings, space comfort, or other criteria, in some embodiments.

Quantifying the typical energy use information (e.g., demand, etc.) for each of the electric loads can include the use of a mathematical model of the energy use characteristics. The model can be calculated based on measured historical data.

The control commands can include pre-programmed operating setpoints or demand limits expressed as a percentage of the full load (e.g., maximum) rating of the controlled load.

The electric demand reduction capability can be calculated from the values of the respective control setting, the energy use (e.g., electric demand) model, and the full load rating of the electric load. In some embodiments, the method can include receiving a notification of the start or end of a particular event (whose purpose is to reduce electric demand). The start notification can be utilized to initiate the electric demand reduction of the number of electrical loads. In some embodiments, the end notification returns the electrical loads to normal operation.

In various embodiments, the model can utilize an industry standard mathematical algorithm or custom designed mathematical algorithm. Quantifying the typical energy use information (e.g., demand, etc.) for each of the electric loads can be based on a set of constant values (rather than a mathematical model based on measured historical data).

In some embodiments, other types of control commands can be used (e.g., on/off, a percentage level, etc.).
An example system embodiment can, for example include a computing device including instructions to:
receive electric demand or consumption data from a number of electrical loads,
quantify the typical energy use information (e.g., demand, etc.) for each of the electric loads,
define control commands or settings for modifying the loads operating condition (e.g., to reduce electric demand) to be sent to each of the electric loads during periods when a reduction in electric demand is required,
quantify the electric demand reduction capability that is available for each of the electric loads during periods when a demand reduction is required,
quantify the total electric demand reduction capability that is available for (a summation of) the combined set of electric loads during periods when a demand reduction is required,
receive notification (start and end) of the occurrence of a pre-defined event whose purpose is to reduce electric demand (e.g., a demand reduction event),
send control commands to the electric loads during times of normal operations, as well as during a demand reduction event,
export a set of data that quantifies the total estimated electric demand reduction for the combined set of electric loads. Quantifying the typical energy use information (e.g., demand, etc.) for each of the electric loads can include the use of a mathematical model of the energy use characteristics. The model, for example, can be calculated based on measured historical data.

In some embodiments, the electric demand reduction capability is calculated from the values of the respective control setting, the energy use (e.g., electric demand) model, and the full load rating of the electric load. In various embodiments, the control commands can be adjusted by the electric customer to manage the customer's objectives for energy use, cost savings, space comfort, or other criteria.

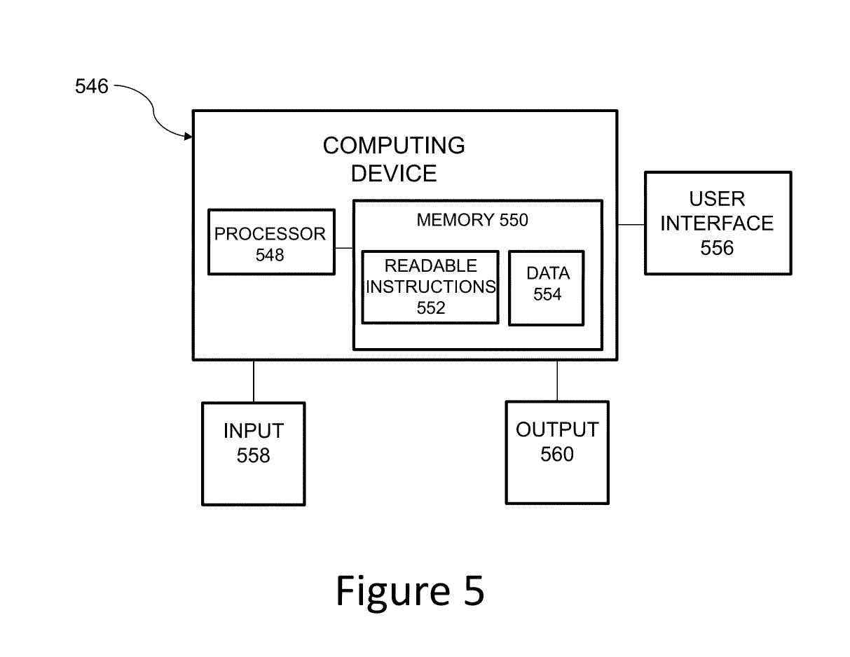

FIG. 5 illustrates a computing device that can be utilized according to one or more embodiments of the present disclosure. For instance, a computing device 546 can have a number of components coupled thereto. The computing device 546 can include a processor 548 and a memory 550. The memory 550 can have various types of information including data 554 and executable instructions 552, as discussed herein.

The processor 548 can execute instructions 552 that are stored on an internal or external non-transitory computer device readable medium (CRM). A non-transitory CRM, as used herein, can include volatile and/or non-volatile memory. Volatile memory can include memory that depends upon power to store information, such as various types of dynamic random access memory (DRAM), among others. Non-volatile memory can include memory that does not depend upon power to store information.

Memory 550 and/or the processor 548 may be located on the computing device 546 or off of the computing device 546, in some embodiments. As such, as illustrated in the embodiment of FIG. 3, the computing device 546 can include a network interface having input and/or output capabilities (e.g., input 558 and output 560 connections). Such an interface can allow for processing on another networked computing device and/or can be used to obtain data and/or executable instructions for use with various embodiments provided herein.

When used as a facility controller device, the computing device 546 can utilize inputs and outputs (e.g., 558 and 560) to communicate with other networks or other devices including the DBP coordinator and one or more devices that are drawing electric loads.

As illustrated in the embodiment of FIG. 3, the computing device 546 can include a user interface 556 that allows a user to review instructions and/or data on the device 546. Such an interface can be used to review electric loads and change settings, among other functions, as described herein.

Presented below are several example embodiments. In one method embodiment, the method of demand bidding operation includes determining a potential electric demand reduction for a particular facility (e.g., through use of an interface as shown in FIG. 2). In some embodiments, determining a potential electric demand reduction for a particular facility includes determining a potential electric demand reduction for multiple buildings (e.g., a campus or other facility having one or more buildings, and in this example, two or more buildings) having electrical control from the same computing device (e.g., a facility controller).

The method also includes determining a bid for demand reduction based upon the determined potential electric demand reduction. The method also includes submitting, via a computing device, the bid for demand reduction to a computing device of an electrical demand coordinating entity.

Also included in the method is receiving, via a computing device, notification of a triggering event that will trigger the demand reduction based upon the bid. In some embodiments, the notification can also include a triggering event duration, for example, a time period or a start time and/or an end time. As discussed herein, the triggering event notification can be received as an electronic signal indicating a need to reduce electric demand. In some embodiments, the settings of controllable loads can be automatically adjusted (via executable instructions processed by a processor on a computing device) to reduce electric demand based on the demand reduction bid.

The method can also include adjusting, via a computing device, demand at the particular facility based upon the demand reduction of the bid. In some embodiments, adjusting the demand also includes adjusting the demand based on the duration of the event.

In another example, an energy demand control device includes instructions thereon that are executable by a processor to determine a potential electric demand reduction for a set of controlled electric loads of a particular facility. Such a potential electric demand reduction can be determined, for example, by providing data collected from a number of electrical loads indicating a quantity of power consumed by each controlled load.

Such a potential electric demand reduction can also be determined, for example, by providing data collected from the controlled loads indicating electric demand for each of the controlled loads at multiple time intervals. In some embodiments, the potential electric demand reduction can be determined by analyzing each selected particular load to determine the potential electric demand reduction.

The potential electric demand reduction can also be determined by analyzing a time profile of electric demand for each controlled load as calculated from a determined period of past operational history of the load during which no triggering event occurred. For example, a time profile can include providing demand reductions for time segments based on a variety of factors, such as time of day, peak or off-peak, cost of the electricity, and/or criticality of the device drawing the load, among other factors. In some embodiments, analyzing a time profile of electric demand as calculated from a determined period of past operational history of the load during which no triggering event occurred can include automatically recalculating the time profile of electric demand for each controlled load.

In various embodiments, determining a potential electric demand reduction includes analyzing a time profile of electric demand as calculated from estimates determined and provided, via the computing device, by a user.

In some embodiments, the device can include an opt-out control that allows a user to select or deselect a particular load for participation in electric demand reduction.

This example device also includes instructions to determine a bid for demand reduction based upon the determined potential electric demand reduction. In some embodiments, determining a bid for demand reduction can include determining a time-based set of estimated electric demand reduction values for multiple time periods.

Determining a bid for demand reduction may also be determined with multiple time-based sets of estimated electric demand reduction values for multiple time periods. In some such embodiments, the device can compare a potential demand reduction time period with the multiple sets of time-based estimated electric demand reduction values to determine a combination of the time-based set of values that coincide with the potential demand reduction time period. For example, if a reduction event is to take place at 1-3 pm, the time-based set of values coinciding with that 1-3 pm time period can be analyzed without analyzing the data values of the other time periods that may be available.

This example device also includes instructions to submit, via a computing device, the bid for demand reduction to a computing device of an electrical demand coordinating entity. The device also receives, via a computing device, notification of a triggering event that will trigger the demand reduction based upon the bid and adjusts, via a computing device, demand at the particular facility based upon the demand reduction of the bid.

In various embodiments, the device can also include comparing a potential demand reduction time period with the time-based set of estimated electric demand reduction values to determine a subset of the time-based set of values that coincide with the potential demand reduction time period.

Also, some embodiments may include receiving, via a computing device, notification of an end of reduction triggering event that will end the demand reduction and adjusting, via a computing device, demand at the particular facility based on the receipt of the end of reduction triggering event.

In an additional method embodiment, the method for controlling a set of electric loads, includes quantifying typical energy use information (e.g. demand, etc.) for each of the electric loads, defining control commands or settings for modifying the loads operating condition (e.g. to reduce electric demand) to be sent to each of the electric loads during periods when a reduction in electric demand is required, quantifying the electric demand reduction capability that is available for each of the electric loads during periods when a demand reduction is required, and quantifying the total electric demand reduction capability that is available for (a summation of) the combined set of electric loads during periods when a demand reduction is required.

The energy use information, control commands, and demand reductions can be defined for specific time intervals (e.g. hours), and are associated with the occurrence of a pre-defined event whose purpose is to reduce electric demand. In some embodiments, the control commands can be adjusted by the electric customer to manage the customer's objectives for energy use, cost savings, space comfort, or other criteria. The control commands can include pre-programmed operating setpoints, or demand limits expressed as a percentage of the full load (e.g. maximum) rating of the controlled load. Other types of control commands are used (e.g. on/off, a percentage level, etc.).

Quantifying the typical energy use information (e.g. demand, etc.) for each of the electric loads can include the use of a mathematical model of the energy use characteristics. The model can be calculated based on measured historical data and/or estimates, for example, provided by the user. In some embodiments, quantifying the typical energy use information (e.g. demand, etc.) for each of the electric loads is based on a set of constant values (rather than a mathematical model based on measured historical data).

The electric demand reduction capability can, for example, be calculated from the values of the respective control setting, the energy use (e.g. electric demand) model, and the full load rating of the electric load.

As discussed above, in some embodiments, a notification of the start or end of a particular event (whose purpose is to reduce electric demand) can be received by the facility controller. The start notification can be used to initiate the electric demand reduction of the number of electrical loads. The end notification can be used to return the electrical loads to normal operation.

In a system embodiment, a computing device includes instructions to receive electric demand or consumption data from a number of electrical loads, quantify the typical energy use information (e.g. demand, etc.) for each of the electric loads and define control commands or settings for modifying the loads operating condition (e.g. to reduce electric demand) to be sent to each of the electric loads during periods when a reduction in electric demand is required. The system also includes instructions to quantify the electric demand reduction capability that is available for each of the electric loads during periods when a demand reduction is required, quantify the total electric demand reduction capability that is available for (a summation of) the combined set of electric loads during periods when a demand reduction is required. The embodiment also includes instructions to receive notification (start and end) of the occurrence of a pre-defined event whose purpose is to reduce electric demand (e.g. a demand reduction event), send control commands to the electric loads during times of normal operations, as well as during a demand reduction event, and export a set of data that quantifies the total estimated electric demand reduction for the combined set of electric loads.

In some embodiments, quantifying the typical energy use information (e.g. demand, etc.) for each of the electric loads can include the use of a mathematical model of the energy use characteristics. The model is calculated based on measured historical data. The electric demand reduction capability can be calculated, for example, from the values of the respective control setting, the energy use (e.g. electric demand) model, and the full load rating of the electric load. As discussed above, the control commands can be adjusted by the electric customer to manage the customer's objectives for energy use, cost savings, space comfort, or other criteria.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of characteristics” can refer to one or more characteristics.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, if claims are provided, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim, if claims are provided. Rather inventive subject matter lies in less than all features of a single disclosed embodiment.

What is claimed:

1. A method of demand bidding operation, comprising:
determining a potential electric demand reduction for a particular facility;
determining a bid for demand reduction based upon the determined potential electric demand reduction;
submitting, via a computing device, the bid for demand reduction to a computing device of an electrical demand coordinating entity;
receiving, via a computing device, notification of a triggering event that will trigger the demand reduction based upon the bid; and
adjusting, via a computing device, demand at the particular facility based upon the demand reduction of the bid.

2. The method of claim 1, wherein determining a potential electric demand reduction for a particular facility includes providing data collected from a number of electrical loads indicating a quantity of power consumed by each controlled load.

3. The method of claim 1, wherein determining a potential electric demand reduction for a particular facility includes providing data collected from a number of controlled loads indicating electric demand for each of the controlled loads at multiple time intervals.

4. The method of claim 1, wherein determining a potential electric demand reduction for a particular facility includes providing an opt-out control that allows a user to select or deselect a particular load for participation in electric demand reduction.

5. The method of claim 1, wherein receiving, via a computing device, notification of a triggering event that will trigger the demand reduction based upon the bid includes receiving an electronic signal indicating a need to reduce electric demand and automatically, via a computing device, alter the settings of controllable loads to reduce electric demand based on the demand reduction bid.

6. The method of claim 1, wherein determining a potential electric demand reduction for a particular facility includes determining a potential electric demand reduction for multiple buildings having electrical control from the same computing device.

7. An energy demand control device having instructions thereon that are executable by a processor to:
determine a potential electric demand reduction for a set of controlled electric loads of a particular facility;
determine a bid for demand reduction based upon the determined potential electric demand reduction;
submit, via a computing device, the bid for demand reduction to a computing device of an electrical demand coordinating entity;
receive, via a computing device, notification of a triggering event that will trigger the demand reduction based upon the bid; and
adjust, via a computing device, demand at the particular facility based upon the demand reduction of the bid.

8. The device of claim 7, wherein determining a potential electric demand reduction for a particular facility includes providing data collected from a number of electrical loads indicating a quantity of power consumed by each controlled load.

9. The device of claim 7, wherein determining a potential electric demand reduction for a particular facility includes providing data collected from a number of controlled loads indicating electric demand for each of the controlled loads at multiple time intervals.

10. The device of claim 7, wherein control device includes an opt-out control that allows a user to select or deselect a particular load for participation in electric demand reduction.

11. The device of claim 10, wherein determining a potential electric demand reduction for a particular facility includes analyzing each selected particular load to determine the potential electric demand reduction.

12. The device of claim 7, wherein determining a potential electric demand reduction for a particular facility includes analyzing a time profile of electric demand for each controlled load as calculated from a determined period of past operational history of the load during which no triggering event occurred.

13. The device of claim 12, wherein analyzing a time profile of electric demand as calculated from a determined period of past operational history of the load during which no triggering event occurred includes automatically recalculating the time profile of electric demand for each controlled load.

14. The device of claim 7, wherein determining a potential electric demand reduction for a particular facility includes analyzing a time profile of electric demand as calculated from estimates determined and provided, via the computing device, by a user.

15. The device of claim 7, wherein determining a bid for demand reduction based upon the determined potential electric demand reduction includes determining a time-based set of estimated electric demand reduction values for multiple time periods.

16. The device of claim 15, further including comparing a potential demand reduction time period with the time-based set of estimated electric demand reduction values to determine a subset of the time-based set of values that coincide with the potential demand reduction time period.

17. The device of claim 7, further including receiving, via a computing device, notification of an end of reduction triggering event that will end the demand reduction and adjusting, via a computing device, demand at the particular facility based on the receipt of the end of reduction triggering event.

18. The device of claim 7, wherein determining a bid for demand reduction based upon the determined potential electric demand reduction includes determining multiple time-based sets of estimated electric demand reduction values for multiple time periods.

19. The device of claim 15, further including comparing a potential demand reduction time period with the multiple sets of time-based estimated electric demand reduction values to determine a combination of the time-based set of values that coincide with the potential demand reduction time period.

20. A non-transitory computer-readable medium having instructions stored thereon executable by a processor to:
determine a potential electric demand reduction for a particular facility;
determine a bid for demand reduction based upon the determined potential electric demand reduction;
submit, via a computing device, the bid for demand reduction to a computing device of an electrical demand coordinating entity;
receive, via a computing device, notification of a triggering event that will trigger the demand reduction based upon the bid; and
adjust, via a computing device, demand at the particular facility based upon the demand reduction of the bid.
